(19) United States
(12) Patent Application Publication
(10) Pub. No.: US 2016/0196624 A1
(43) Pub. Date: Jul. 7, 2016

(54) A Method, Process and System for Facilitation and Management of Real Estate Transactions

(71) Applicant: REALESTATE.COM.AU PTY LTD, Richmond, Victoria (AU)

(72) Inventor: Asaf Brukarz, Cremorne (AU)

(21) Appl. No.: 14/911,904

(22) PCT Filed: Aug. 14, 2014
(86) PCT No.: PCT/AU2014/000810

§ 371 Date: Feb. 12, 2016

(30) Foreign Application Priority Data
Aug. 15, 2013 (AU) 2013903086
Sep. 5, 2013 (AU) 2013903410

(51) Int. Cl. G06Q 50/16; G06Q 30/06

(52) U.S. Cl. CPC G06Q 50/16; G06Q 30/0601

(57) ABSTRACT

A process to facilitate the reservation of a right to sell a piece of real estate, wherein said process includes the following steps: a first party publishing a listing of a piece of real estate; wherein the listing at least includes information selected from the following group of data relevant to the piece of real estate: address; lot number; current status reservation fee; and price data; and wherein the first party approves at least one second party; the second party who interacts with said listing by indicating their intention to reserve the said right; the second party pays a reservation fee to the first party; and a second party arranges for the sale of the piece of real estate from the first party to a third party.

### TECHNICAL FIELD

The present invention relates to a method, process and system for facilitation and management of real estate transactions. Preferably, this invention may include computer or software based implementation of the aforementioned method, process and/or system.

### BACKGROUND

U.S. Pat. No. 6,684,196 discloses an online automated system for the trading of real estate property across the internet. However this system and process described in '196 is aimed to connect real estate owners who want to sell with purchasers while the process or system acts through a website and operates as a virtual agent. This system doesn't encourage the growth of a sales network to sell real estate property.

US Patent Application No. 2005/0288958 discloses an online marketplace for real estate transactions whereby the real estate is locatable by the use of image map of the preferred geographical region of importance to the person seeking to buy a piece of real estate.

US Patent Application No. 2006/0190278 discloses an online real estate transaction system for connecting potential property investors and matching them with potential investment properties.

US Patent Application No. 2008/0319890 discloses an online real estate transaction system wherein real estate is purchased by an online auction model where bids are placed in real. The website in the '890 disclosure acts as an intermediary party or agent selling the piece of real estate from the original to the purchaser.

Any discussion of the prior art throughout the specification should in no way be considered as an admission that such prior art is widely known or forms part of common general knowledge in the field.

### SUMMARY

### Problems to be Solved

The background art in relation to processes, methods and systems of facilitating real estate transactions has focused on the relationship between the real estate owner and the real estate purchaser. This approach ignores the input and work of intermediary parties and agents to sell a piece of real estate through a Sales Network. Additionally, these previous processes and systems don't encourage an increase in the likelihood of real estate sales. Additionally, these systems may fail to deliver advantages to property developers who wish to sell multiple real estate properties at the same or similar address.

These intermediary parties may include: traditional real estate agents and also all of their contacts which may function as sub intermediary parties.

One of the aims of the present invention is to encourage multiple intermediaries to work on behalf of the real estate owner to sell the property. Generally, the more intermediary parties working to sell a piece of real estate the higher likelihood of selling the particular piece of real estate.

It is an object of the present invention to overcome or ameliorate at least one of the disadvantages of the prior art, or to provide a useful alternative.

### Means for Solving the Problem

A first aspect of the present invention may relate to a process, method or system for facilitating transactions preferably in relation to real estate transactions.

A second aspect of the present invention may relate to a process to facilitate the reservation of a right to sell a piece of real estate, wherein said process includes the following steps: A first party publishing a listing of a piece of real estate; wherein the listing at least includes information selected from the following group of data relevant to the piece of real estate: address; lot number; current status reservation fee; and price data; and wherein the first party approves at least one second party; the second party who interacts with said listing by indicating their intention to reserve the said right; the second party pays a reservation fee to the first party; and a second party arranges for the sale of the piece of real estate from the first party to a third party.

Preferably, the process is operated by a computer connected to the internet and acting as a webserver. The first party may also be a Supplier or Development Owner.

Preferably, the second party is selected from one of the following group: Seller, Subseller or Sales Network. Further, the third party may be the Purchaser of the piece of real estate.

Preferably, the data relating to the current status may include the following designations: Held, Pending Reservation, Awaiting Approval; Reserved; Under Contract; Sold; and Settled.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 depicts a schematic diagram of the relationship of Sellers and Subsellers as per the first preferred embodiment of the present invention also referred to in this specification as a Sales Network;

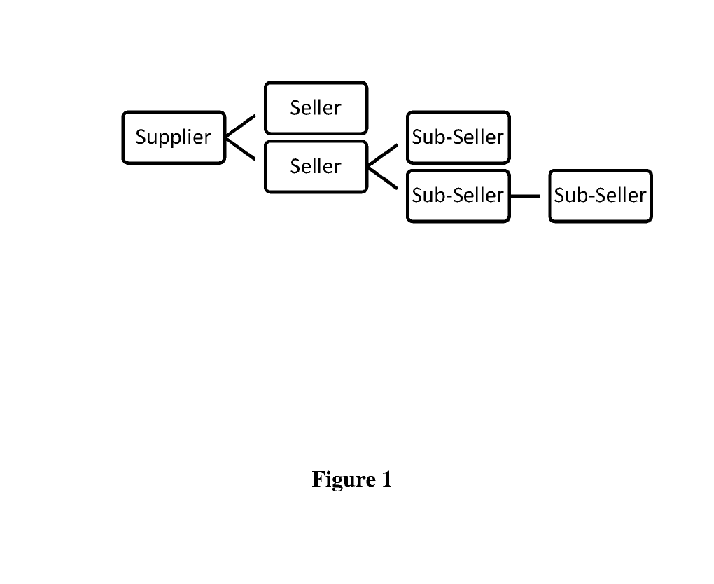

FIG. 2 depicts a schematic view of a flowchart relating to a Reservation Phase of a preferred embodiment of the present invention;

FIG. 3 depicts a schematic view of a flowchart relating to a Reservation Phase of a further preferred embodiment of the present invention;

FIG. 4 depicts a schematic view of a flowchart relating to a Reservation Phase of a further preferred embodiment of the present invention;

FIG. 5 depicts a schematic view of a flowchart relating to a Reservation Phase of a further preferred embodiment of the present invention;

FIG. 6 depicts a schematic view of a flowchart relating to a Reservation Phase of a further preferred embodiment of the present invention; and

FIG. 7 depicts a schematic view of a flowchart relating to a Reservation Phase of a further preferred embodiment of the present invention.

### DESCRIPTION OF THE INVENTION

Preferred embodiments of the invention will now be described with reference to the accompanying drawings and non-limiting examples.

The first preferred embodiment of the present invention generally includes a computer-implemented process, method and/or system for the facilitation and management of real estate property transactions (wherein referred to as the System). The System allows an authorised user (the Supplier) in a computer-based network to input the data required to create a real-estate property listing (the Property) on the System and make the Property available for viewing by other authorised users (the Seller). The System can automatically determine a Seller's authority to sell a Property when a Property has been received from multiple Suppliers.

The System

The System may include the hardware and software sufficient to effect the described processes of the embodiments of the present invention. Preferably, the System would include a computer designated as a Server. This Server may function as a web enabled server for the distribution of data through browsing technology and protocols across the Internet. Preferably, a Website and Database is written in software and adapted to be run and distributed from the Server.

The Server is preferably accessed by Client Computers which are adapted to interact with the Server to complete the System. The Client Computers are preferably operated by the Suppliers or Sellers or Subsellers, depending on the circumstances. There are many Client Computers connected to the Server at any one time. The Suppliers or Sellers or Subsellers are preferably authenticated by security logins operated through the Website run by the Server.

Client Computers may include: laptop and desktop PCs, mobile smart phones, tablets, Google Glass™ or any other web browser enabled electronic device.

Users (i.e. Suppliers, Sellers, Subsellers, Purchasers) of the online System may be authenticated using standardised security protocols and verification procedures. Once verified, these Users become Authenticated Users of the System. Preferably, the System may also record data regarding the Authenticated Users including: access times, geographical information, IP addresses, emails, addresses, and passwords.

Preferably, the System uses or includes the processes described in relation to preferred embodiments of the present invention.

The System aims to encourage the expansion of the Sales Network by encouraging multiple Sellers and Subsellers to act or work for the Supplier. Further Authenticated Users may invite Sellers who in turn become Authenticated Users and can invite further Sellers and/or Subsellers. This process may be continued indefinitely whereby more Sellers and Subsellers are invited to participate in selling the piece of real estate as identified in the listing. Preferably, the Sales Network is approved and regulated by the Supplier through the online web portal running on the Server computer.

Creating a Property

Preferably, the System prompts the Supplier to make a listing relating to the piece of real estate they own and wish to sell. In this specification, Property means the listing of the piece of real estate to be sold.

Preferably, the listing is made on a secured website wherein the publication of the listing data is only made available to authenticated Sellers, Subsellers or Sales Network as approved by the Supplier.

The data required to create a Property may include:
An address describing the location of the Property;
If the Property is part of a multi-dwelling subdivision, either in an apartment complex, or a housing development, the address includes an identifier that uniquely identifies the Property from other properties at that address (the Lot Number);
A list price for the Property—this is the advertised price that the Supplier is willing to accept for the sale of the Property; and
Other details of the Property that would assist a Seller in selling the Property including:
   The size of internal and external areas of the property
   The number of bedrooms, bathrooms and car spaces of the property
   The form of the available car spaces (for example, garage, carports or undercover secured parking)
   Costs of holding the property, including rates and fees payable to councils and water/power supply authorities
   The expected rent that a property could attain
   Details of any shared facilities available to the property, such as gymnasiums and pools
   Details of the surrounding area, including nearby schools, shops and other facilities

To make the Property available to a Seller, the Supplier or the Sales Network is generally required to add a specific Seller to an approved list of Sellers who are authorised to sell the Property. The Seller can be identified by e-mail address or company name.

Making a Property Available to a Seller

The original creator of a Property is known as the Property Owner and usually an Authenticated Supplier of the piece of real estate (wherein the ownership of the property has been verified by the System). A Property Owner is able to use the System to make a Property available for Sale to one or more Sellers. The System notifies approved Sellers, Subsellers or Sales Network. Once a Seller has received access to sell a Property, they are known as Approved Sellers.

Any Approved Seller can make a Property received from a Supplier available to another Seller known as a Subseller. The Subseller is then able to sell any Property that they have received from the Seller. This process can be repeated indefinitely to any persons forming a Sales Network. The connection between a Supplier, a Seller and any Sub-Sellers is known as a Sales Chain or Sales Network.

Any Approved Seller or the Property Owner can choose to make a Property available to one or more Subsellers on an Exclusive basis. When a Property is Exclusively made available to one or more Sellers, the System may automatically make the Property unavailable to all other Sellers and their Subsellers. When the Property is no longer made Exclusive, the system may make the Property available to again to the Supplier's Sellers.

If a Supplier removes an Approved Seller's access to sell a Property, the Seller will no longer be able to sell that Property and any Subsellers that the Seller had appointed to sell the Property also lose access to sell the Property, unless those Subsellers had received access to sell the Property from another Authorised Seller.

The Supplier can also choose to set the terms upon which a property transaction (Reservation) is authorised. The Supplier can choose to input the following data into the System:
An amount required to be paid to secure the purchasing rights to the Property (the Reservation Fee), if any;
The amount of time (in hours), if any, that a Seller is allowed to hold the Property, prior to payment of the Reservation Fee (Hold Time);
The number of days that a Reserved Property will remain unavailable for sale by any other Seller, beginning from the time the Reservation Fee is paid (Reservation Period);
Whether the System should automatically cancel Reservations that do not meet their deadlines, thereby returning the Property to the Available status;
Whether the Supplier is required to manually approve a Reservation before it is made unavailable for sale by other Sellers (Offline Reservations);
If the Supplier does not require Offline Reservations, the reservations are known as Live Reservations.

Preferably, each piece of real estate has only a single Active Reservation at a time. Once a Reservation is active in regard to a particular Property, no other people in Sales Network can reserve the Property.

At the point at which a Property is Reserved by a Seller, the System may preferably calculate the Sales Chain that effected the Reservation. The Sales Chain is a list of Sellers and Subsellers beginning with the Property Owner and ending with the Seller that enters the Reservation Form into the System. Only Users within the Sales Chain can see and make changes to the details of the Reservation. All other Users will simply see the Property as unavailable for Sale.

If a Seller has received access to sell a Property from more than one Supplier, the System will choose the shortest Sales Chain that leads from the Seller to the Owner. If two or more Sales Chains have the same length, the System will choose the Sales Chain that was created first.

Property Statuses

All Properties that do not have a current transaction have a status of Available. In this embodiment, Properties may have the following statuses:
Available—The Property is available for sale by authorised Sellers.
Held—The Property is held pending the payment of the Reservation Fee.
Pending Reservation—A Seller has initiated a Reservation on the Property and is awaiting Approval from the Supplier.
Reserved
   If the Supplier requires manual approval, the Supplier has approved the Reservation; or
   If the Supplier requires payment of a Reservation Fee, the Reservation Fee has been paid; or
   If the Supplier requires payment of a Reservation Fee, and the Supplier requires manual approval, the Reservation Fee has been paid, and the Supplier has approved the Reservation; or
   If the Supplier requires neither payment of a Reservation Fee or manual approval, the Seller has entered the data required to create a Reservation.
   Under Contract—The Seller has indicated to the System that Contracts have been signed and are being returned to the Seller.
   Sold—The Supplier has indicated to the System that Contracts of Sale for the Property have been received and that the conditions of the Contract (including any deposit monies) have been satisfied.
   Settled—The Supplier has indicated to the System that the property transaction has been settled and that ownership of the Property has been transferred.

The Reservation Phase and Steps

Reservation Form

In this embodiment, a member or user from the Sales Network proceeds to make a Reservation in relation a Property. To create a Reservation on a Property, a Seller or member of the Sales Network approves and enters into the System the minimum details required to reserve a Property (the Reservation Form). These minimum details may include:
The Property that the Purchaser wishes to Purchase;
The Purchaser's full name;
The Purchaser's address and contact details, including phone number and email address;
The purchase price of the Property, if different from the List price; and
The contact details for the Purchaser's legal representative; and
The Seller's acceptance of the Terms and Conditions provided by the System and the Seller.

Once a Seller or Subseller has successfully completed a Reservation Form, the system will either:
1. Change the status of the Property to Held if the Supplier allows Live Reservations; or
2. Change the status of the Property to Pending Reservation if the Supplier requires manual approval.

Payment

If the Supplier has requested payment for the Reservation, and the Supplier has provided the System with a valid number of hours for the Hold Time (above 0), the Seller has until the expiry of the Hold Time to pay for the Reservation. The Hold Time is the number of hours specified by the Supplier, beginning from the time the Reservation Form was submitted.

If the Seller fails to pay the Reservation Fee by the expiry of the Hold Time, the System will automatically cancel the Reservation, mark the Property as Available and notify both the Seller and the Supplier that the Reservation has been cancelled.

If the Seller successfully pays the Reservation Fee prior to the expiry of the Hold Time, the Property will either have a status of Reserved, or a status of Pending Reservation, depending on whether the Supplier requires manual approval or not.

The Seller is able to process payment for the Reservation Fee by a number of methods, including a cheque, bank funds transfer or credit card. All methods, other than a credit card, require the Supplier to manually receipt the funds. It is noted that online automated system of payment may be also used including Paypal™ etc.

The System will notify the Seller by e-mail at pre-determined periods prior to the automatic cancellation of the Reservation. These notifications serve as a warning to the Seller that they must process payment by the expiration of the Hold Timer or the Reservation will be cancelled.

Manual Approval

If the Supplier requires manual approval, the System will notify the Supplier by Electronic Mail (e-mail) and request the Supplier's approval or rejection of the reservation.

Until the Supplier has approved or rejected the Reservation, other Sellers can place other Pending Reservations on the same Property. When a Supplier approves a Reservation, any other Pending Reservations on that Property will be cancelled and the Sellers of those Pending Reservations will be notified by e-mail.

When a Supplier approves a Reservation the Property will be marked as Reserved.

Contract Signing

Once a Seller or Subseller has an approved Reservation on a Property, the Seller has until the expiry of the Reservation Period to provide signed Contracts of Sale to the Supplier. The expiry of the Reservation Period is the Contract Due Date.

If the Seller fails to return Contracts of Sale to the Supplier by the expiry of the Reservation Period, the Supplier is able to cancel the Reservation. Upon cancelling the Reservation, the system will make the Property Status Available and notify the Seller and the Supplier that the Property is now “Available” for sale.

The Supplier is able to extend the Reservation Period indefinitely, at their discretion. The Supplier extends the Reservation by indicating to the System the new Contract Due Date. The new Contract Due Date must occur after the previous Contract Due Date.

Both the Supplier and the Seller can indicate to the System that Contracts have been signed, at which point the Reservation will no longer expire. Once either the Supplier or the Seller has indicated to the System that Contracts have been signed, the Property's status is changed to Under Contract. The date at which Contracts have been signed is known as the Contract Exchanged Date.

Deposit Payment

After the Contracts of Sale have been exchanged, the Purchaser is required to pay a deposit on the sale of the Property to the Supplier. The Deposit is required within 14 days of the Contract Exchanged Date. This is known as the Deposit Due Date.

The Supplier is required to indicate to the System the date at which the Deposit was paid. This is known as the Deposit Paid Date. The Supplier is able to change the Deposit Due Date at any time after the Contract Exchanged Date has been set.

Once the Supplier has indicated to the System that the Deposit has been received, the system will update the status of the Property to Sold.

Property Settlement

Property settlement can occur at any time after a Property is Reserved. To mark the Property as Settled, the Supplier will indicate to the System the date at which Settlement occurred. This is known as the Settlement Date.

Reservation Cancellation

Either the Supplier or the Seller is able to cancel any Reservation that they have created. Once a Reservation has been cancelled, both the Supplier and the Seller are notified by e-mail and the System changes the status of the Property to Available.

Overdue Items

A Reservation that has past its due date for a particular step is known as an Overdue Reservation. The System will alert the Supplier and Seller via e-mail when an item becomes overdue, requesting that the item is either extended, or marked as complete, or cancelled. Respective parties are notified electronically by the System wherein the Reservation is cancelled or withdrawn.

Comments on Listing

Suppliers and Sellers are able to add comments to the Property or listing at any step of the Reservation. Comments are marked with the date and time they were entered and are made visible to both the Supplier and Seller/Subseller.

Additional description of flowcharts and processes

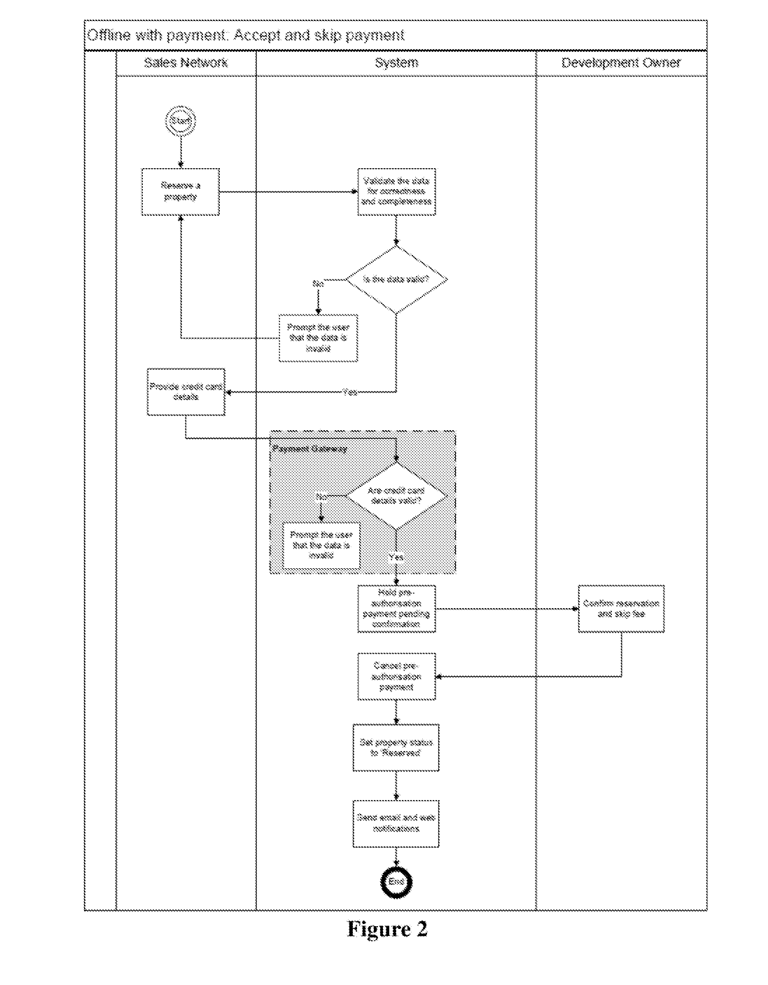

FIG. 2 depicts a schematic view of a process or system in the form of a flowchart. The flowchart is divided into three vertical columns depicting decisions and actions: Sales Network; System; and Development Owner. In this embodiment and example of the invention, the Sales Network is designated to mean all of people working to sell a particular piece of Real Estate and may include the network of Sellers, and Sub-Sellers which was abovementioned.

In relation to FIGS. 2 to 7, the Sales Network refers to one or more Sellers, Subsellers. However, only one Seller or Subseller may activate the Reservation Process or Phase at one time and the System manages this process.

The System in this embodiment referred to computerised process by which the process is operated and is described in greater detail above.

The Development Owner is the person(s) who own the piece of real estate that is to be the subject of the process.

FIG. 2 depicts the steps and processes involved in the Reservation Phase of the System. In this example, Reservation Phase is directed to an offline process with payment incorporated into the processes. Preferably, a representative of the Sales Network indicates their intention to reserve the property. The System then may validate the data for completeness and correctness, if the validation is successfully, the System requests payment via credit card and/or payment gateway (eg Paypal™ etc.) from the Sales Network.

Once, the registration fee has been paid a preauthorisation hold is placed on the particular listing. The System prompts the Development Owner to confirm reservation and skip fee.

Upon the confirmation of the Development Owner, the System cancels the pre authorisation payment and sets the Property status to “Reserved” and then sends notifications and emails to all relevant parties. Please note that the prompting and notifications may include any of the following forms of communication: SMS Text Message, Email, on-screen messages on website, Internet browser popup messages, Internet Chat Message, phone call, or printed letter.

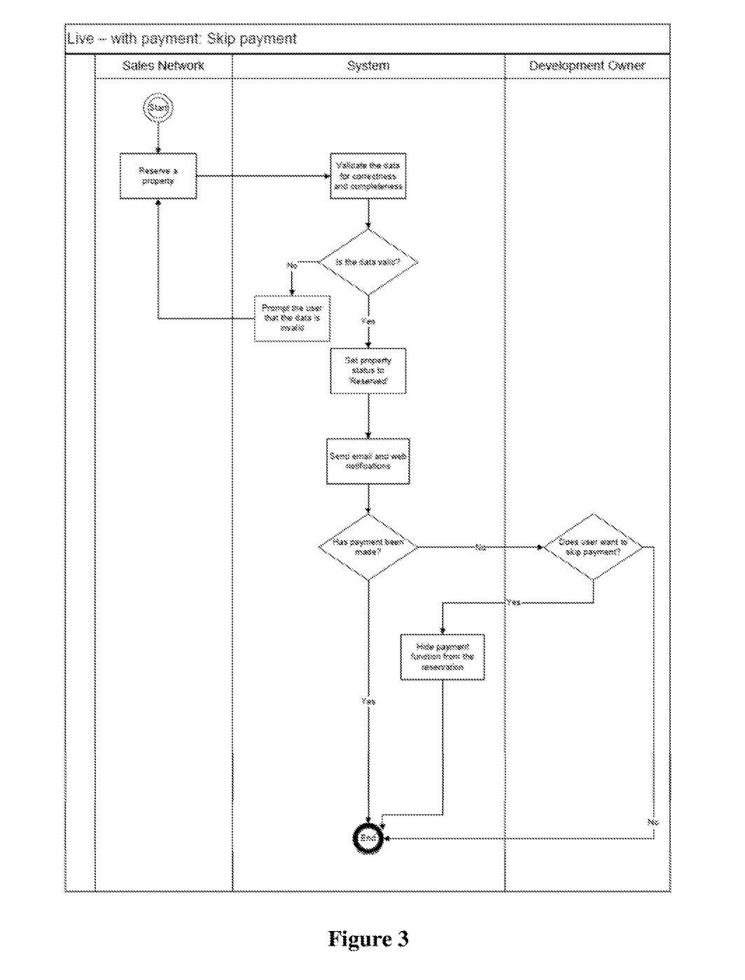

FIG. 3 depicts an alternate Reservation Phase to FIG. 2. In this embodiment, the Reservation is online and live through the Server and internet. The system additionally prompts the Development Owner to make a decision as to whether to skip the payment stage of the Reservation Phase or not. In most other respects the process is similar to the steps shown in FIG. 2.

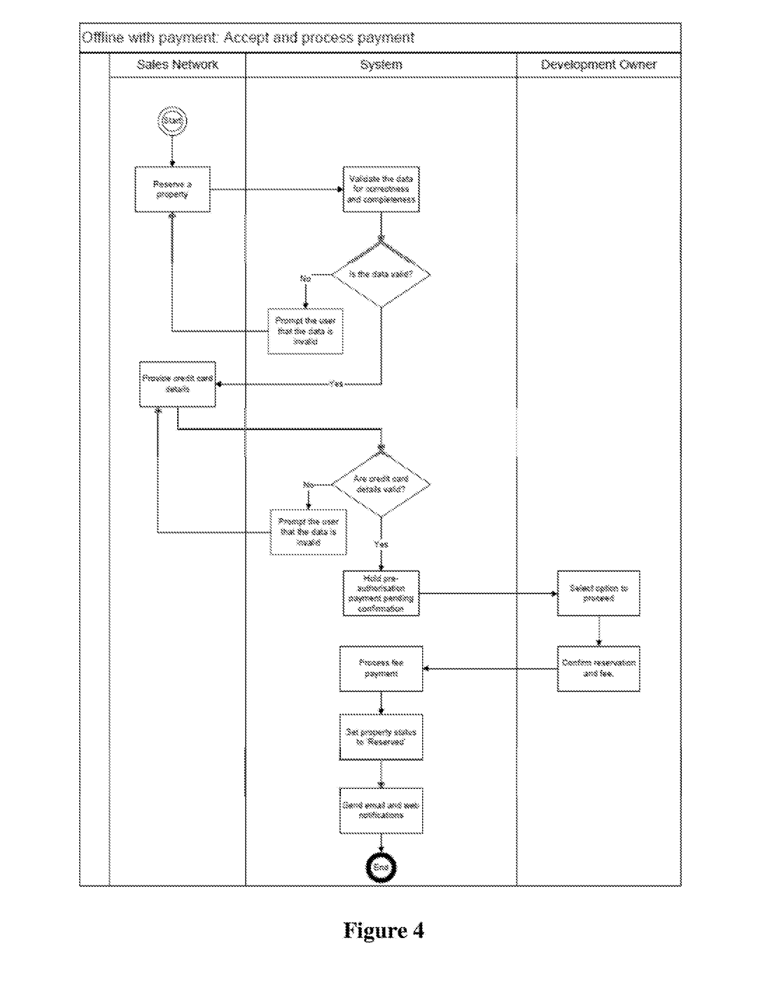

FIG. 4 depicts an alternate Reservation Phase to FIG. 2. In this embodiment, the process is regulated mostly offline and this process includes a mandatory system of reservation fee payment being paid by the Sales Network to the Development Owner. In most other respects the process is similar to the steps shown in FIG. 2.

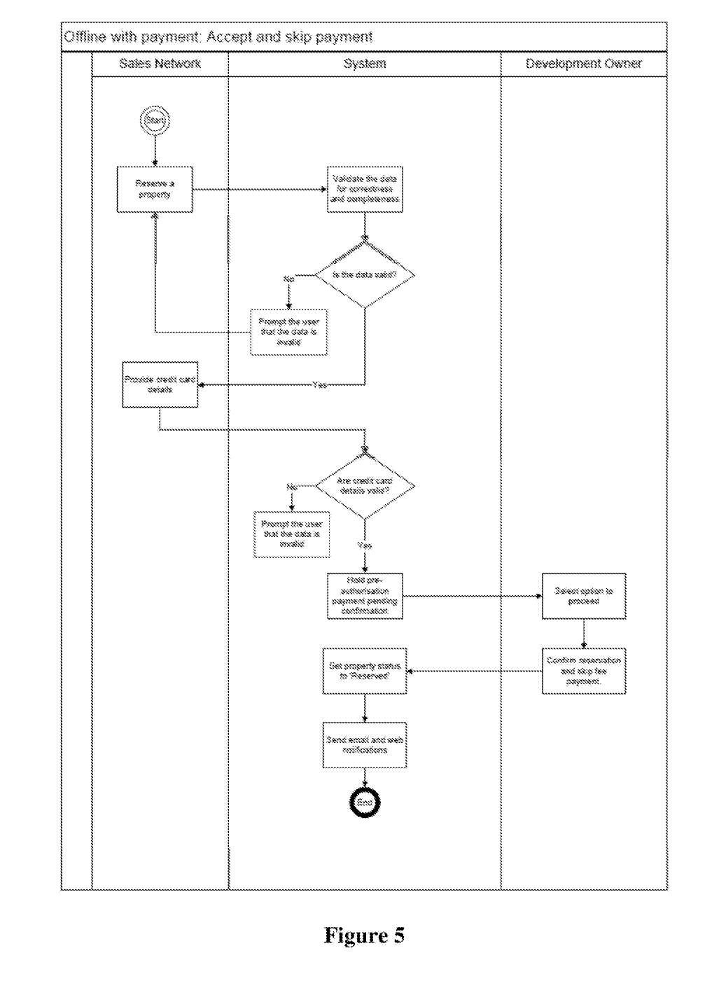

FIG. 5 depicts a further Reservation Phase similar to FIG. 2. In this embodiment, the process may be an offline system wherein the reservation fee payment may be skipped at the approval of the Development Owner. In most other respects the process is similar to the steps shown in FIG. 2.

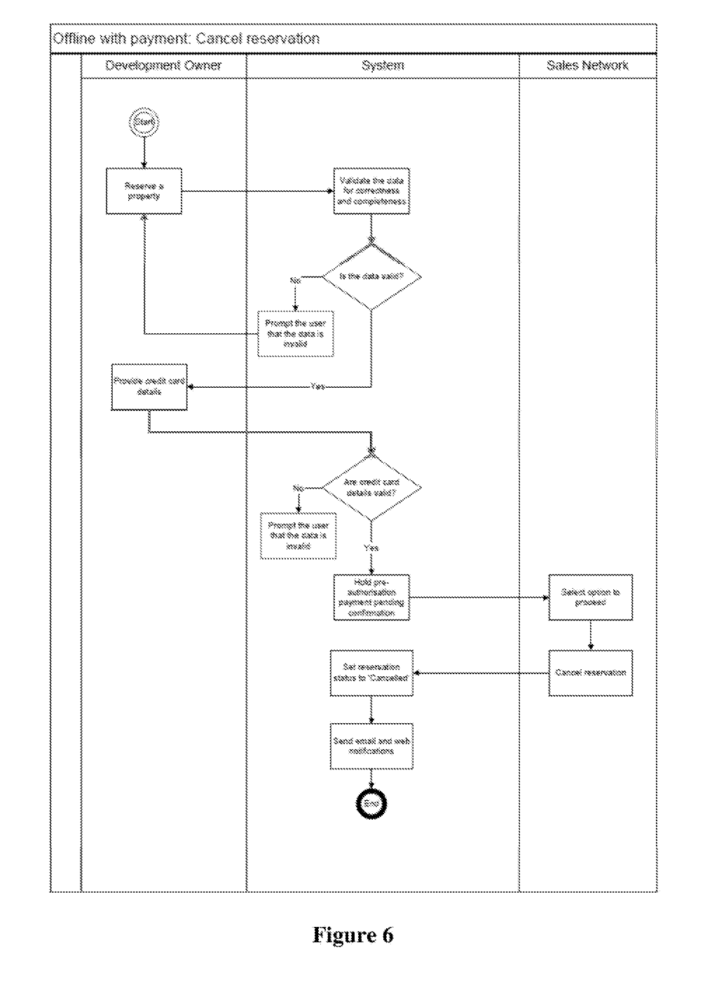

FIG. 6 depicts a further Reservation Phase similar to FIG. 2. In this embodiment, the process has hypothetically proceeds in an offline environment with a reservation fee payment being made. However the reservation is cancelled by the Development Owner's notification to the System and the reservation fee is returned to the Sales Network. In most other respects the process is similar to the steps shown in FIG. 2.

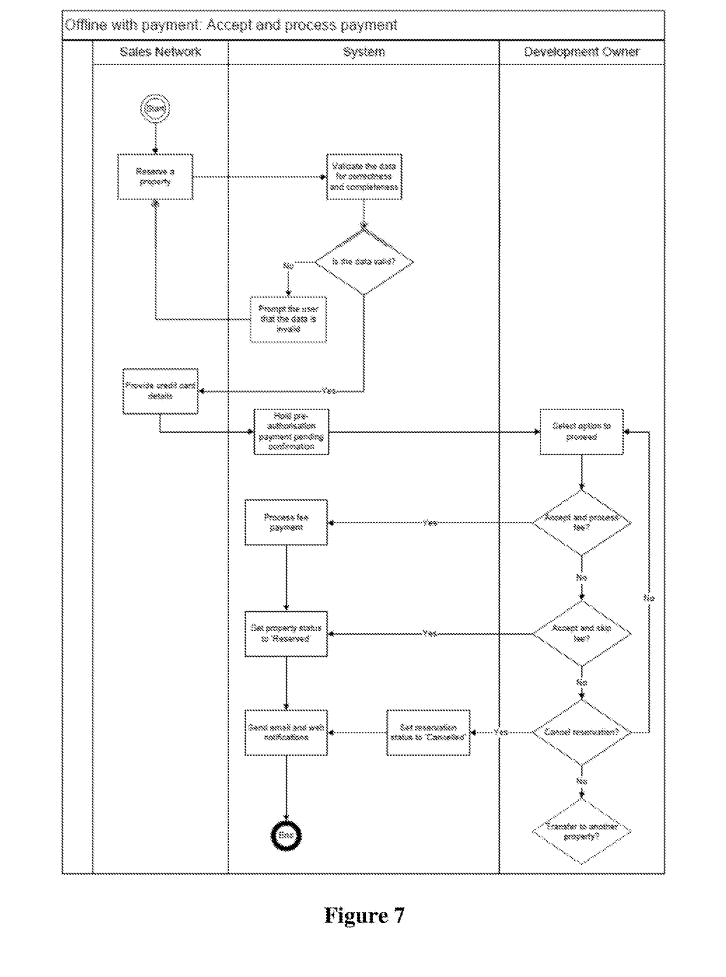

FIG. 7 depicts a further Reservation Phase similar to FIG. 2. In this embodiment, the process has hypothetically proceeded in an offline environment with a reservation fee payment being made. The reservation fee has been accept and approved by the Development Owner. In most other respects the process is similar to the steps shown in FIG. 2.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

The following table is a Glossary of Terms used throughout this specification

| | |
|---|---|
| Available | The Status of a Property that has no Active Reservation |
| | and is available for Sale by Approved Sellers |
| Active | Any Reservation that is not cancelled or Pending |
| Reservation | Reservation |
| Approved | Any Seller on the System who has been authorised to |
| Seller | Sell a Property |
| Contract | The date for Contracts of Sale to be returned to |
| Due Date | the Supplier. Calculated as Reservation Fee Paid |
| | Date + Reservation Period |
| Contract | The date that the Contracts of Sale were signed by |
| Exchanged | the Supplier |
| Date | |
| Contract | Written Contracts of Sale for real estate |
| of Sale | |
| Deposit | The date that the deposit for the purchase of real |
| Due Date | estate is due |
| Deposit | The date that the deposit for the purchase of real |
| Paid Date | estate was paid |
| Fee Paid | The date that the Reservation Fee was paid |
| Date | |
| Held | The Status of a Property that has a Reservation |
| | Form created, but does not have a payment or |
| | approval from the Supplier |
| Hold Period | The number of hours that a Seller has to complete |
| | payment for the Reservation |
| Live | A Reservation where the Property is automatically |
| Reservation | made Available or Reserved by the System |
| Lot Number | A number uniquely identifying a Property within a |
| | multi-dwelling subdivision |
| Offline | A Reservation that requires manual approval by a |
| Reservation | Supplier before it can proceed |
| Overdue | A Reservation where the current step that requires |
| Reservation | completion is past its due date |
| Pending | A Property with a Seller that has completed a Reservation |
| Reservation | Form where the Supplier requires manual approval |
| Property | The listing of a single piece of tradeable real |
| | estate may include an address and price |
| Property | The original creator of a Property in the System |
| Owner | |
| Property | The status of a single Property in the System |
| Status | |
| Reservation | A sale transaction occurring on a Property in the System |
| Reservation | The fee required to be paid by a Seller to secure |
| Fee | and progress a Reservation |
| Reservation | The form that is required to be completed by a |
| Form | Seller to create a Reservation on a Property |
| Reservation | The time that the System will allow between payment |
| Period | of the Reservation Fee and the Contract Due Date |
| Reservation | The current step hi the progress of the Reservation |
| Step | |
| Reserved | The Status of a Property that has an approved Reservation |
| Sales Chain | A collection of links between a Supplier, a Seller |
| | and any number of Sub-Sellers |
| Seller | The user on the System who is selling a Property |
| Settlement | The date at which ownership of the Property changes |
| Date | from Supplier to Purchaser |
| Sold | The status of a Property in the System that has a |
| | Deposit paid and Contracts exchanged |
| Supplier | The creator of a Property within the System |
| Terms and | A set of legally binding terms and conditions supplied |
| Conditions | by both the System (as defaults) and the Supplier |
| Under | The status of a Property in the System where either |
| Contract | the Seller or the Supplier have indicated that |
| | Contracts of Sale have been signed |

1. A process to facilitate the reservation of a right to sell a piece of real estate, wherein said process includes the following steps:
a. A first party publishing a listing of a piece of real estate; wherein the listing at least includes information selected from the following group of data relevant to the piece of real estate: address; lot number; current status reservation fee; and price data; and
wherein the first party approves at least one second party;
b. The second party who interacts with said listing by indicating their intention to reserve the said right;
c. The second party pays a reservation fee to the first party; and
d. A second party arranges for the sale of the piece of real estate from the first party to a third party.

2. The process of claim 1, wherein the process is operated by a computer connected to the internet and acting as a webserver.

3. The process of claim 1, wherein the first party is a Supplier or Development Owner.

4. The process of claim 1, wherein the second party is selected from one of the following group: Seller, Subseller or Sales Network.

5. The process of claim 1, wherein the third party is the Purchaser of the piece of real estate.

6. The process of claim 1, wherein the information relating to current status includes the following designations: Held, Pending Reservation, Awaiting Approval; Reserved; Under Contract; Sold; and Settled,
